(19) United States
(12) Patent Application Publication
(10) Pub. No.: US 2008/0140836 A1
(43) Pub. Date: Jun. 12, 2008

(54) Computer management server in remote access environment

(76) Inventors: Toui Miyawaki, Kawasaki (JP); Kiminori Sugauchi, Yokohama (JP); Shinichi Hayashi, Kawasaki (JP)

Correspondence Address: MCDERMOTT WILL & EMERY LLP, 600 13TH STREET, N.W., WASHINGTON, DC, 20005-3096, US

(21) Appl. No.: 11/907,707

(22) Filed: Oct. 16, 2007

(30) Foreign Application Priority Data
Oct. 16, 2006 (JP) 2006-280882
Aug. 23, 2007 (JP) 2007-216588

(51) Int. Cl. G06F 15/173

(52) U.S. Cl. 709/225

(57) ABSTRACT

In a remote access environment such as a thin client system, there are problems in that a user cannot be informed as to whether a user's computer can be accessed upon activation thereof, or as to whether termination of the computer is completed upon termination thereof, and that an administrator cannot manage computer status of an entire system, leading to delay in identifying failure occurrences. As a solution, a system is provided which includes three management servers including: a reception server which receives an access request from a user; a computer control server which performs power control of a target computer of the access request; and a switch control server which performs access control of the computer; the computer including an agent function which notifies the computer control server of progress of control within the computer; and progress of connecting, which often keeps a user waiting, is notified to the user through the computer control server, to relieve user stress, reduce waiting time, and provide an administrator with information on operational status of the entire system.

### BACKGROUND OF THE INVENTION

The present invention relates to a system in which a computer on a network is remotely controlled.

There is a thin client system in which a user provides a necessary application or data to the user's own computer, which is on a network, and remotely accesses the application or the data by using a thin client terminal provided with minimal functions such as a display function and an input function.

For the thin client system, conventional technology exists as disclosed in Japanese Patent Laid-open Publication No. 2005-327233 (herein after, referred to as Patent Document 1) for controlling power supply to a computer or the like, existing on a network.

Patent Document 1 discloses the invention for providing a remote access environment to a user, which allows the user to remotely transmit a power-on request and a power-off request to a user's computer. However, Patent Document 1 does not disclose a change of state of the computer after those requests are transmitted to the computer.

If the change of state is not checked after the transmission of the request, it is impossible to determine whether the computer has been completely started up to a state in which it can be used by the user, even if power-on processing has been performed. Also, even if the power-off processing is performed, it is impossible to determine whether the computer has been completely turned off. Accordingly, the user cannot identify when to start and end an operation, and an administrator of the system cannot comprehend the entire operating state of the user's computer within the system.

In view of the above, it is necessary to make it possible to comprehend the state of the computer control in the thin client system.

### SUMMARY OF THE INVENTION

The present invention provides a thin client system which includes: a front reception function which receives a request from a user terminal; a computer control function which performs control of a remote computer upon request; an agent function which is provided to a computer and notifies the computer control function of a change of state of the computer; and a switch control function which performs access control of a user before and after the control of the remote computer, in which the agent function detects a change of state of the remote computer and notifies the computer control function of the change of state, and the computer control function notifies, through the front reception function, the user terminal of a control result of the remote computer, to thereby allow the user to check, when controlling the computer of the user, the progress of the control.

Also, according to the present invention, the user causes the user terminal to inquire the change of state of the remote computer and to determine the result thereof, to thereby check the progress of the control.

According to a specific embodiment of the present invention, there is provided a remote access system, in which one or more user terminals access one or more access destination devices through one or more filtering devices connected via a network.

The remote access system includes a management server, in which, in response to a request from one of the user terminals, the management server controls one of the access destination devices and performs access control of one of the access destination devices through a filtering function provided to each of the access destination devices, according to a type of the request, and discloses information on the access destination device to the user terminal.

Further, the management server includes, for example, the front reception function of receiving a request from the user terminal, the access destination device control function of controlling the access destination device according to a request from the user terminal, the switch control function of performing access control with respect to the access destination device, and a management database function of collectively managing the state of the access destination device based on the change of state of the access destination device notified thereto by the access destination device, in which the access destination device includes the agent function of notifying the change of state of the access destination device to the access destination device control function of the management server.

Also, the remote access system further includes a storage device, in which the management server may further include a storage management function of performing control of allocation and mounting of the storage device with respect to the access destination device.

Also, the access destination device control function of the management server may notify the user terminal of a control result of the access destination device with respect to a request from the user terminal.

Also, the management server may include a management interface for allowing an administrator to perform a state check of the system, and the management interface may notify the administrator, in response to a request from the administrator, of the states of the access destination devices in the entire system.

According to another specific embodiment of the present invention, there is provided a remote access system, in which one or more user terminals access one or more access destination devices.

The remote access system includes a management server, in which, in response to a request from at least one of the user terminals, the management server controls at least one of the access destination devices and performs access control of at least one of the access destination devices by using a filtering function provided to each of the access destination devices, according to a type of the request, and discloses information on the access destination device to the user terminal.

According to further another specific embodiment of the present invention, there is provided a remote access system, in which one or more user terminals access one or more access destination devices through a filtering device on each of the access destination devices.

In the remote access system, the user terminals each directly make a request to one of the access destination devices, control of the access destination device and access control of the access destination device through the filtering function provided to the access destination device are performed according to a type of the request, and information on the access destination device is disclosed to the user terminal.

The present invention may be applied to another configuration in which an access control function is not provided to the access destination device.

The present invention provides the following effects.

(1) A user can check whether a computer of the user is available or not when controlling the computer, and unfailingly cause the computer to perform a next process following a connection process, a suspension process of a program, or the like.

(2) An administrator can monitor a state of operation of an entire system based on actual states of computers.

### BRIEF DESCRIPTION OF THE DRAWINGS

In the accompanying drawings:

FIG. 1 illustrates a thin client system according to Embodiment 1 of the present invention;

FIG. 2 illustrates a correspondence relation between a physical configuration and a logical configuration of each management server according to Embodiment 1;

FIG. 3 illustrates a correspondence relation between a physical configuration and a logical configuration of a blade according to Embodiment 1;

FIG. 4 illustrates a correspondence relation between a physical configuration and a logical configuration of a user terminal according to Embodiment 1;

FIG. 5 illustrates an operation (model diagram) of a system of the present invention as a whole according to Embodiment 1;

FIG. 6 illustrates a data structure of a management database according to Embodiment 1;

FIG. 7 illustrates a connection operation (sequence diagram) according to Embodiment 1;

FIG. 8 illustrates an interruption operation (sequence diagram) according to Embodiment 1;

FIG. 9 illustrates a termination operation (sequence diagram) according to Embodiment 1;

FIG. 10 illustrates an application example (system configuration diagram) of the present invention applied to a storage centric system according to Embodiment 2 of the present invention;

FIG. 11 illustrates a correspondence relation between a physical configuration and a logical configuration of a storage management server according to Embodiment 2;

FIG. 12 illustrates a correspondence relation between a physical configuration and a logical configuration of a storage device according to Embodiment 2;

FIG. 13 illustrates a connection operation (sequence diagram) according to Embodiment 2;

FIG. 14 illustrates a termination operation (sequence diagram) according to Embodiment 2;

FIG. 15 illustrates a thin client system configuration according to Embodiment 3 of the present invention;

FIG. 16 illustrates a connection operation (sequence diagram) according to Embodiment 3;

FIG. 17 illustrates an interruption operation (sequence diagram) according to Embodiment 3;

FIG. 18 illustrates a termination operation (sequence diagram) according to Embodiment 3;

FIG. 19 illustrates a thin client system configuration according to Embodiment 4 of the present invention;

FIG. 20 illustrates a connection operation (sequence diagram) according to Embodiment 4;

FIG. 21 illustrates a termination operation (sequence diagram) according to Embodiment 4;

FIG. 22 illustrates a thin client system configuration according to Embodiment 5 of the present invention;

FIG. 23 illustrates a connection operation (sequence diagram) according to Embodiment 5; and

FIG. 24 illustrates a termination operation (sequence diagram) according to Embodiment 5.

### DESCRIPTION OF THE PREFERRED EMBODIMENTS

Hereinbelow, embodiments of a computer control system according to the present invention are described with reference to the accompanying drawings.

The embodiments described below assume a blade-type computer in which a plurality of remote computers are integrated on a rack to be controlled and managed, and each of the plurality of remote computers is formed of one or more circuit boards (blades). The remote computer is referred to as blade.

### Embodiment 1

Embodiment 1 is described by taking a thin client system as an example, using a thin client terminal as a user terminal, accessing a blade corresponding to a server device (simply referred to as server) remotely located, via a network such as the Internet or an intranet, with user control of the user's own blade.

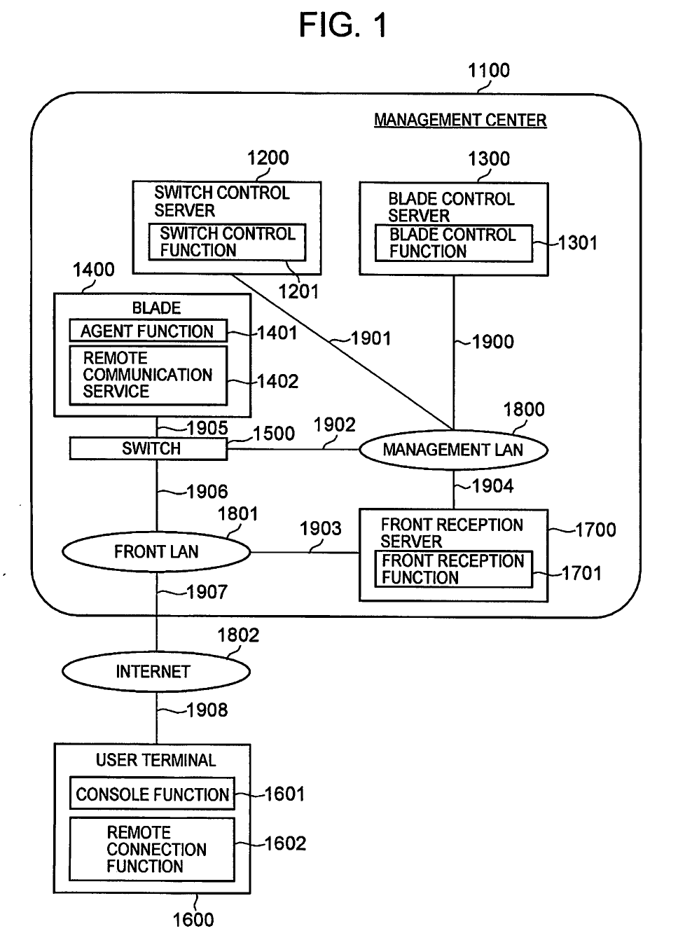

FIG. 1 shows a configuration of the thin client system according to Embodiment 1 of the present invention.

The thin client system includes, in a management center 1100, a switch control server 1200 having a switch control function 1201, a blade control server 1300 having a blade control function 1301, a front reception server 1700 having a front reception function 1701, a switch 1500, a blade 1400 having an agent function 1401 and a remote communication service 1402, and a user terminal 1600 having a console function 1601 and a remote connection function 1602.

The switch control server 1200, the blade control server 1300, and the front reception server 1700 are each connected to a management LAN 1800 via lines 1901, 1900, and 1904, respectively. Also, the blade 1400 is connected to a front LAN 1801 via lines 1905 and 1906 and the switch 1500. Further, the front LAN 1801 is connected to the Internet 1802 via a line 1907, and the Internet 1802 is connected to the user terminal 1600 via a line 1908. In this case, the front reception server 1700 is connected to the management LAN 1800 via the line 1904 and to the front LAN 1801 via a line 1903.

In Embodiment 1, to ensure confidentiality of the system, management traffic is enclosed in the management LAN 1800 and configured as a network that is distinct from the front LAN 1801 and the Internet 1802. However, it is technically possible to configure those three networks as networks different from one another or as being in the same network.

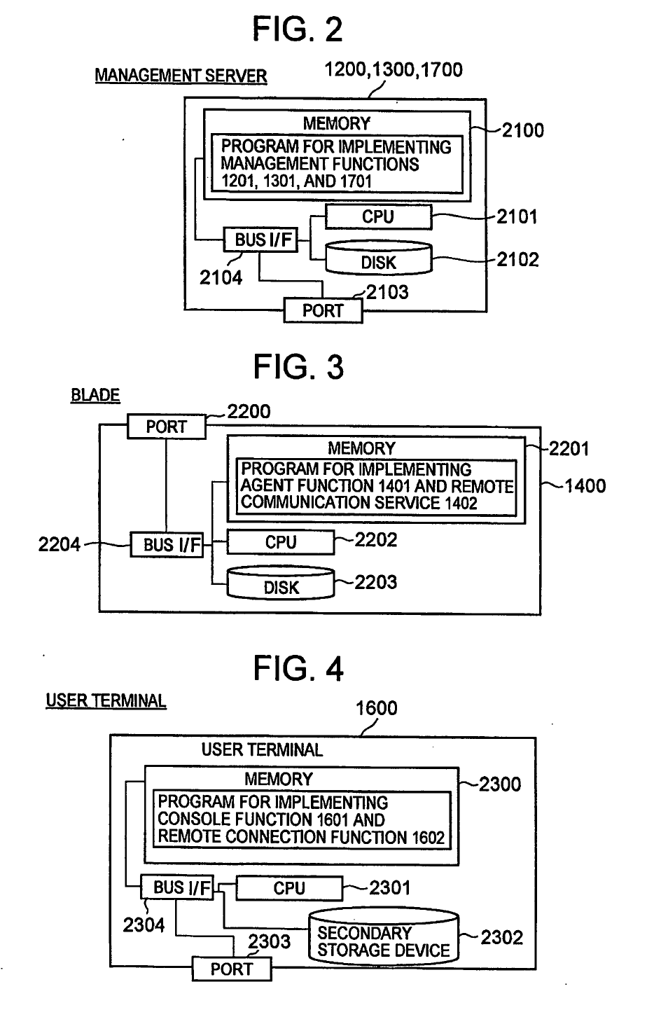

FIGS. 2 to 4 each illustrate a correspondence relation between a physical configuration and a logical configuration in each of the devices.

The switch control server 1200, the blade control server 1300 and the front reception server 1700 (herein after, collectively referred to as management servers) each have a configuration shown in FIG. 2. The management servers 1200, 1300, and 1700 each include a memory 2100, a CPU 2101, and a disk 2102 as a secondary storage device (herein after, a hard disk is referred to as a disk; the same applies to other devices), each being connected to one another via an interior communication line such as a bus IF 2104 (herein after, referred to as a bus; the same applies to other devices). The memory 2100 and the disk 2102 each store programs for implementing the switch control function 1201, the blade control function 1301, and the front reception function 1701 (herein after, collectively referred to as management functions), which are each provided to the management servers, respectively.

Further, the disk 2102 of the front reception server 1700 stores a database for management (herein after, referred to as management database), which is referred to and updated by each of the management servers for performing user authentication and blade control. In the memory 2100, a process for executing the reference and updating process of the management database, in response to a request from each of the management servers, is running.

In Embodiment 1, the management database is stored on the front reception server 1700. However, the storage location of the management database is not limited thereto, as long as the management database is accessible from each of the management servers. Accordingly, the management database may be stored on another management server such as the switch control server 1200 or the blade control server 1300. Alternatively, a dedicated management server for storing the management database may be additionally provided. Also, the management servers each have at least one port 2103 for connecting to the management LAN 1800. However, the front reception server 1700 may include two or more ports 2103 because the front reception server 1700 also connects to the front LAN 1801.

Further, in Embodiment 1, the management functions (1201, 1301, and 1701) are installed on different servers. However, the management functions may be installed on a single server, or may be installed on a plurality of servers. There is no specific limitation imposed on where the management functions should operate.

The blade 1400 has a configuration as shown in FIG. 3 and includes a memory 2201, a CPU 2202, and a disk 2203 connected via a bus IF 2204. The memory 2201 and the disk 2203 each store a program for implementing the agent function 1401. The blade 1400 also includes a port 2200 for receiving access from a user. The port 2200 is connected to the line 1905.

The user terminal 1600 includes a memory 2300, a CPU 2301, a secondary storage device 2302 used as a program storage area, which are connected via a bus IF 2304. The memory 2300 and the secondary storage device 2302 each store a program for implementing the console function 1601. The user terminal 1600 also includes a port 2303 for accessing the blade 1400, and the port 2303 is connected to the line 1907. In this case, a nonvolatile semiconductor memory may be employed as the secondary storage device 2302. Alternatively, a write-protect disk or an ordinary disk may also be employed as the secondary storage device 2302.

The above-mentioned functions described in Embodiment 1 are realized as processes when programs for implementing the functions are executed by the CPU 2101, 2202, or 2301. Hereinbelow, Embodiment 1 is described mainly in terms of the functions and the processes.

Further, the above-mentioned programs may be stored on the disks 2102 and 2203, and the secondary storage device 2302 in advance, or may be introduced as necessary to the disks 2102 and 2203, and the secondary storage device 2302 from other devices through the ports 2103, 2200, and 2303, an I/O interface (not shown), and a medium that can be used by a computer. The medium refers to, for example, a removable storage medium that can be attached to the I/O interface, or a communication medium (i.e., a network, or a carrier wave or digital signal which propagates through a network).

A main role of each of the functions is described below. The front reception function 1701 has a function for receiving a request from the user terminal 1600. The blade control function 1301 has a function of controlling the blade 1400 in response to a request from a user. The agent function 1401, which is provided to the blade 1400, has a function of notifying the blade control function 1301 of a change of state of the blade 1400. The switch control function 1201 has a function of controlling access from a user before and after the blade control.

The remote communication service 1402 is a service for providing a work environment on the blade 1400 to the user terminal 1600 which is remotely located. The remote communication service 1402 is activated along with the activation of the blade 1400. The remote connection function 1602 is a client service for obtaining the work environment on the blade 1400 which is remotely located, by connecting to the remote communication service 1402. The remote connection function 1602 is activated along with the activation of the user terminal 1600 or the console function 1601. The console function 1601 is a user interface which accepts a user operation (a connection operation, an interruption operation, or a termination operation) and actually transmits a request (a connection request, an interruption request, or a termination request) to the front reception function 1701, to thereby control the blade 1400 corresponding to the user terminal 1600.

Next, a description is given of an operation of the system according to Embodiment 1.

When a user at a remote location performs any one of the connection operation, the interruption operation, and the termination operation by using the console function 1601 of the user terminal 1600, the console function 1601 transmits, to the front reception server 1700, any one of the requests (any one of the connection request, the interruption request, and the termination request) corresponding to the operation of the user, through the Internet 1802 and the front LAN 1801.

When the console function 1601 transmits the request to the front reception function 1701, the console function 1601 also transmits authentication information by including the authentication information into the request, the information certifying that an authorized user is making the request. The authentication information includes a user identifier capable of uniquely identifying the user who has made the request. In Embodiment 1, the user identifier is included in the authentication information. However, another configuration may be adopted in which the user identifier is included in the request as a parameter when the request is made, instead of being included in the authentication information.

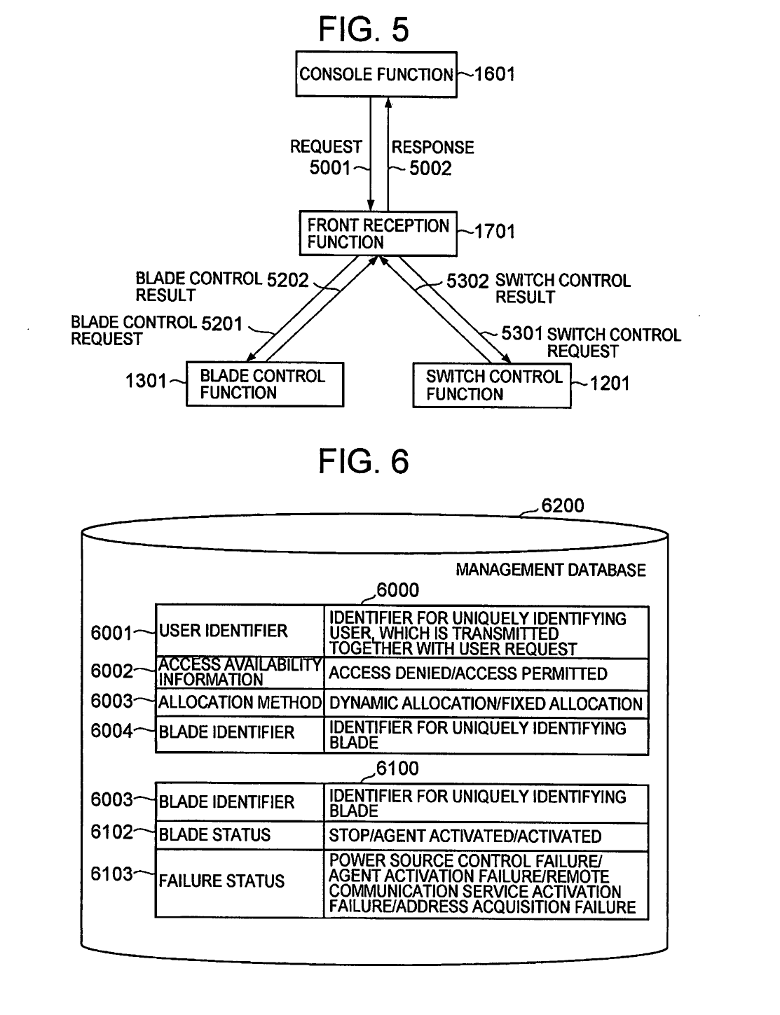

FIG. 5 is a model diagram illustrating operations of the management servers 1200, 1300, and 1700 on the management center 1100 when a user requests blade control in the system of Embodiment 1.

The user transmits a request to the front reception function 1701 by using the console function 1601, the request being with respect to the blade 1400 corresponding to the user terminal 1600 of the user. The user makes any one of three kinds of requests, the connection request, the interruption request, and the termination request, when requesting the blade control. The front reception function 1701, which has received one of the requests, transmits a blade control request 5201 to the blade control function 1301 in response to the request and receives a result 5202 thereof, or transmits a switch control request 5301 to the switch control function 1201 and receives a result 5302 thereof. Lastly, the front reception function 1701 transmits a response 5002 to the console function 1601, in response to each of the results, and waits for another request from the console function 1601.

FIG. 6 illustrates a structure of the management database 6200 provided to the front reception server 1700.

The management database 6200 includes at least a table 6000 (herein after, referred to as user table 6000), which stores information relating to a user, and a table 6100 (herein after, referred to as blade table 6100), which stores information relating to the blade 1400. The user table 6000 is configured by including fields each of which includes a user identifier 6001, access availability information 6002, an allocation method 6003, and a blade identifier 6004. The blade table 6100 is configured by including fields each of which includes a blade identifier 6004, a blade status 6102, and a failure status 6203.

The user identifier 6001 is an identifier for uniquely identifying a user, which is transmitted when a request is made by the user. The access availability information 6002 includes information as to whether or not the user making the request is allowed to access the system, which is registered in advance by an administrator. The allocation method 6003 includes information for designating a method of allocating the blade 1400 to the user, and the administrator registers any one of a dynamic allocation and a fixed allocation as the allocation method. In this case, the dynamic allocation refers to a process of identifying, each time the connection request is made by a user, a blade available to the user and allocating the blade to the user. In cases of the fixed allocation, a blade corresponding to the user is been allocated in advance.

The blade identifier 6004 is an identifier for uniquely identifying a blade. The blade identifier 6004 is shared by the user table 6000 and the blade table 6100 and includes information for managing a correspondence relation between a user and a blade. The blade status 6102 includes information for managing status of the blade control, the status including three kinds of statuses: a suspended status, an agent activation status, and an activation status. The failure status 6103 includes information for managing physical failure information or software failure information of the blade 1400. There are four kinds of failures including a power control failure, an agent activation failure, a remote communication service activation failure, and an address acquisition failure, which are included as the failure status 6103.

Next, a description is given of a process performed by the management servers 1200, 1300, and 1700 for controlling the blade 1400 in response to each one of the connection request, the interruption request, and the termination request, with reference to a sequence diagram indicating a specific procedure.

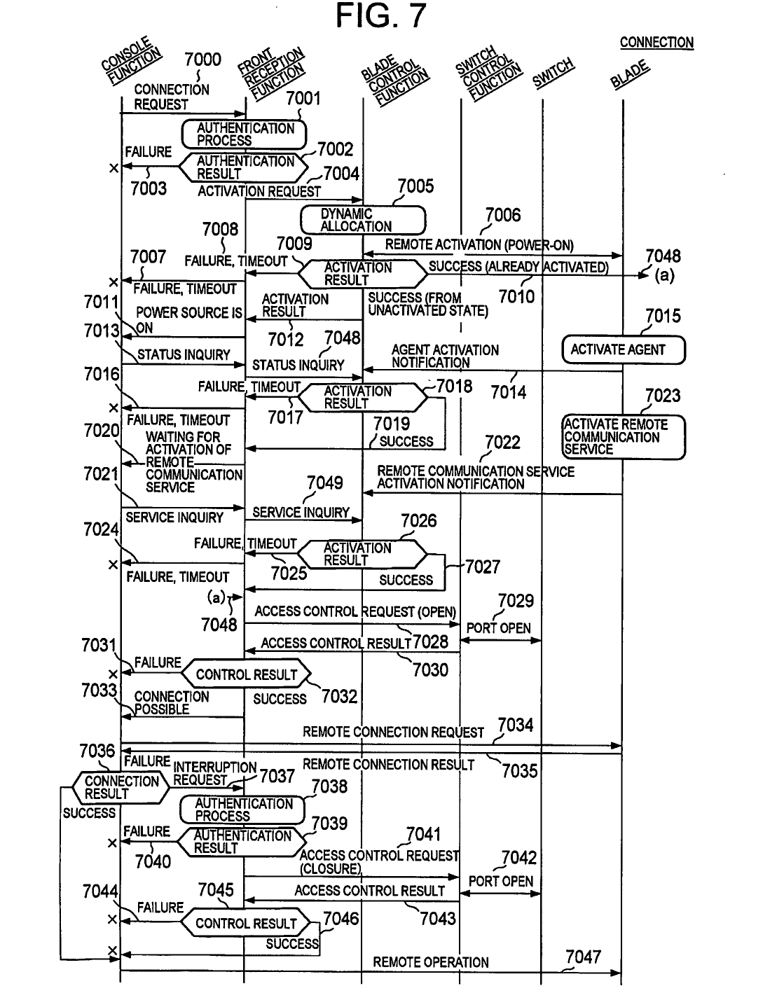

FIG. 7 is a sequence diagram illustrating a connection operation in detail.

When a user connects to the blade 1400 corresponding to the user, the user first transmits a connection request 7000 to the front reception function 1701 by using the console function 1601. The front reception function 1701, which has received the connection request 7000, performs an authentication process 6001 for determining whether the user making the request is an authorized user. Specifically, the front reception function 1701 searches the management database 6200 for the user identifier included in the request. The authentication is judged as being successful when the management database 6200 includes the user identifier corresponding to the user. The authentication is judged as failing when the management database 6200 does not include the user identifier corresponding to the user. When the authentication is judged as failing as a result of the judgment of the authentication result 7002, the front reception function 1701 transmits a response of authentication failure 7003 to the console function 1601, and ends the process. When the authentication is a success, the front reception function 1701 transmits an activation request 7004 including the user identifier, to the blade control function 1301.

The blade control function 1301, which has received the activation request 7004, determines the allocation method of the blade 1400 corresponding to the user, and executes the dynamic allocation if necessary (process 7005). Specifically, the blade control function 1301 searches the management database 6200 based on the user identifier, and obtains information included in the field of the allocation method 6003 corresponding to the user. In cases where it has been determined as a result that the allocation method is the dynamic allocation, a blade 1400 available to the user is identified, and the blade identifier 6004 of the blade 1400 which has been actually allocated to the user is registered.

Next, the blade control function 1301 performs an activation process of a blade, with respect to the blade 1400 remotely installed. Specifically, the blade control function 1301 transmits a remote power ON command to turn on the power to the blade 1400 (process 7006). Next, the blade control function 1301 judges whether the result of the turning on of the power is a success or a failure (process 7009). If the result of the turning on of the power fails, or if no response has been received after a lapse of a predetermined timeout period, the blade control function 1301 responds to the console function 1601 through the front reception function 1701 giving notification of the activation failure, and ends the process (processes 7007 and 7008). There are two cases when the result of the turning on of the power is a success, a case where the power has just been turned on from a suspended state as an initial state, and a case where the power has already been turned on. The difference between the two cases can be obtained as an execution result of the remote power ON command.

First, a description is given of a case where it has been determined that the result of the turning on of the power has been a success, and the power has just been activated from a suspended state.

In this case, the blade control function 1301 transmits the activation result (the success of the activation from the suspended state) to the front reception function 1701 (process 7012). The front reception function 1701, which has received the activation result, transmits a response 7011 indicating that the power is ON, to the console function 1601. The console function 1601 receives the response 7011 indicating that the power is ON, to thereby obtain a hardware activation status. Next, to obtain a software activation status (activation status of the agent function 1401), the console function 1601 transmits a status inquiry request 7013 to the front reception function 1701. Similarly, the front reception function 1701 makes a status inquiry with respect to the blade control function 1301. The blade control function 1301 checks whether an agent activation notification 7014 issued by the agent function 1401 on the blade 1400 has been received. If the agent activation notification 7014 has not been received, the blade control function 1301 waits for the agent activation notification 7014.

Described next is the activation notification issued by the agent function 1401. In response to the turning on of power, power and operating system (OS) are activated and the agent function 1401 which operates on the OS is activated on the blade 1400 (process 7015). At this time, the agent function 1401 transmits, when the agent function 1401 is activated, the agent activation notification 7014 to the blade control function 1301, the agent activation notification 7014 indicating that the agent function 1401 has been activated. The blade control function 1301, which has received the agent activation notification 7014, analyzes the notification and transmits the result of analysis to the front reception function 1701 (process 7018). When the agent activation notification 7014 is received, it is understood that the OS has already been activated on the blade 1400.

In a case where it can be explicitly determined that the agent activation notification is invalid and the process has failed, or in a case where no response has been received even after a lapse of a predetermined timeout period, the blade control function 1301 responds to the console function 1601 through the front reception function 1701 to give notification of the activation failure, and ends the process (processes 7017 and 7016). In cases where the agent activation has succeeded, the blade control function 1301 transmits a response to the effect that the blade control function 1301 is waiting for the activation of the remote communication service 1402, to the console function 1601 through the front reception function 1701 (processes 7019 and 7020).

The console function 1601 receives the response to the effect that the blade control function 1301 is waiting for the activation of the remote communication service 1402, to thereby obtain the activation status of the agent function 1401. Next, to obtain the activation status of the remote communication service 1402, which is necessary for a user to access the blade 1400, the console function 1601 transmits a service inquiry request to the front reception function 1701 (process 7021).

On the other hand, the agent function 1401, which has been activated on the blade 1400, starts monitoring a state of the remote communication service 1402 after the agent function 1401 is activated (the monitoring is preferably started immediately after the activation of the agent function 1401 for user's convenience). The agent function 1401 transmits a service activation notification 7022 indicating an activation result of the remote communication service 1402, to the blade control function 1301, at a time point when the activation 7023 of the remote communication service 1402 has been detected, or when the activation 7023 is not detected even after a lapse of a predetermined timeout period. The blade control function 1301, which has received the service activation notification 7022, analyzes the notification, and transmits the result of analysis to the front reception function 1701 (process 7026).

In a case where it can be explicitly determined that the service activation notification is invalid or that the activation of the remote communication service 1402 has failed, or in a case where no response has been received even after a lapse of the predetermined timeout period, the blade control function 1301 responds to the console function 1601 through the front reception function 1701 to give notification of the activation failure, and ends the process (processes 7025 and 7024). In cases where the service activation has succeeded, the blade control function 1301 transmits a response that the service activation has succeeded, to the front reception function 1701 (process 7027).

The front reception function 1701, which has received the response that the service activation has succeeded, transmits an access control request 7028 to the switch control function 1201 in order to provide a user with access to the blade 1400. The switch control function 1201, which has received the access control request 7028, executes a process of opening the port with respect to the switch 1500 (process 7029). The switch control function 1201 transmits the result of access control to the front reception function 1701 (process 7030).

The front reception function 1701, which has received the result of access control, judges the result of access control (process 7032). In cases where the access control fails, the front reception function 1701 responds to the console function 1601 to give notification of the failure, and ends the process (process 7031). When the access control is a success, the front reception function 1701 transmits a response to the effect that the connection is possible, to the console function 1601 (process 7033). The console function 1601, which has received the response, transmits a remote connection request 7034 to the blade 1400, and obtains a result 7035 of the remote connection request 7034. The console function 1601 judges the result 7035 of the remote connection request 7034 (process 7036).

When it has been judged, as a result of the judgment of the result 7035 of the remote connection request 7034 (process 7036), that the result 7035 of the remote connection request 7034 is a success, the console function 1601 does not transmit an interruption request 7037 to the front reception function 1701, and starts a remote operation from the user terminal 1600 with respect to the blade 1400, by using a connection established from the remote connection function 1602 to the remote communication service 1402 (process 7047).

When the result 7035 of the remote connection request 7034 fails, an attempt is performed to make a request to close a switch port, while keeping the blade 1400 activated. Accordingly, when the result 7035 of the remote connection request 7034 fails, the console function 1601 transmits an interruption request 7037 to the front reception function 1701. The front reception function 1701, which has received the interruption request 7037, performs an authentication process (process 7038) for determining whether the interruption request 7037 has been made by an authorized user, and judges the result thereof (process 7039). When the authentication result fails, the front reception function 1701 transmits a failure response to the console function 1601, and ends the process (process 7040).

The console function 1601, which has received the failure response 7040, displays to the user a warning message to the effect that the remote connection has failed and access control has also failed while the power is turned on, and that the system is therefore vulnerable to unauthorized access, to thereby bring the matter to the attention of the user. In response to this warning message, the user turns off the power of the system, for example, to deal with the situation.

When the authentication result is a success, the front reception function 1701 transmits an access control request 7041 to the switch control function 1201. The switch control function 1201, which has received the access control request 7041, executes a process of closing the port, with respect to the switch 1500 (process 7042). The control function 1201 transmits an access control result to the front reception function 1701 (process 7043). The front reception function 1701, which has received the access control result, judges the access control result (process 7045). In cases where the access control fails, the front reception function 1701 responds to the console function 1601 to give notification of the failure, and ends the process (process 7044).

The console function 1601, which has received the failure response 7044, displays, to the user, a warning message to the effect that the remote connection has failed and access control has also failed, while the power is turned on, and that the system is therefore vulnerable to unauthorized access, to thereby bring the matter to the attention of the user. In response to this, the user turns off the power of the system, for example, to deal with the situation.

When the access control is successful, the front reception function 1701 responds to the console function 1601 to give notification of the success, and ends the process (process 7046). The console function 1601, which has received the success-response 7046, displays a message to the effect that the access control has been normally performed despite the failure of the remote connection. In response to this message, the user tries to reestablish the connection, for example, to deal with the situation.

In cases where it has been judged, as a result of judgment of the activation result with respect to the connection request 7000 (process 7009), that the result of the turning on of the power corresponds to cases where the power has already been turned on, the blade control function 1301 judges that the blade 1400 is in a ready state, and immediately starts a process (process 7048) following the process of opening the port by the access control. The process to be performed following the process of opening the port by the access control is similar to that in cases where the activation is started from an initial state in which the blade 1400 is yet to be activated.

The process as described above is performed in cases where it has been judged that the result of the turning on of the power corresponds to cases where the power has already been turned on.

Also, according to Embodiment 1, in the connection sequence of FIG. 7, the process of the dynamic allocation is performed only once. However, in cases where any problem has occurred in the process of completely activating the blade 1400, including a case where the activation of the agent function 1401 has failed or a case where the activation of the remote communication service 1402 has failed, the blade control function 1301, which has detected the problem, may repeat the dynamic allocation of the blade 1400 to the user. In performing the reallocation process of the blade 1400, the process may be repeated an unlimited number of times, or may be repeated a predetermined number of times set in advance by the administrator. Also, even in a case other than cases where a problem has occurred in the process of completely activating the blade 1400, for example, a case where the access control by the switch control function 1200 has failed, the front reception function 1701 may retransmit the connection request to the blade control function 1301, to thereby perform the reallocation of the blade 1400.

The sequence described above illustrates details of operations when a connection is made.

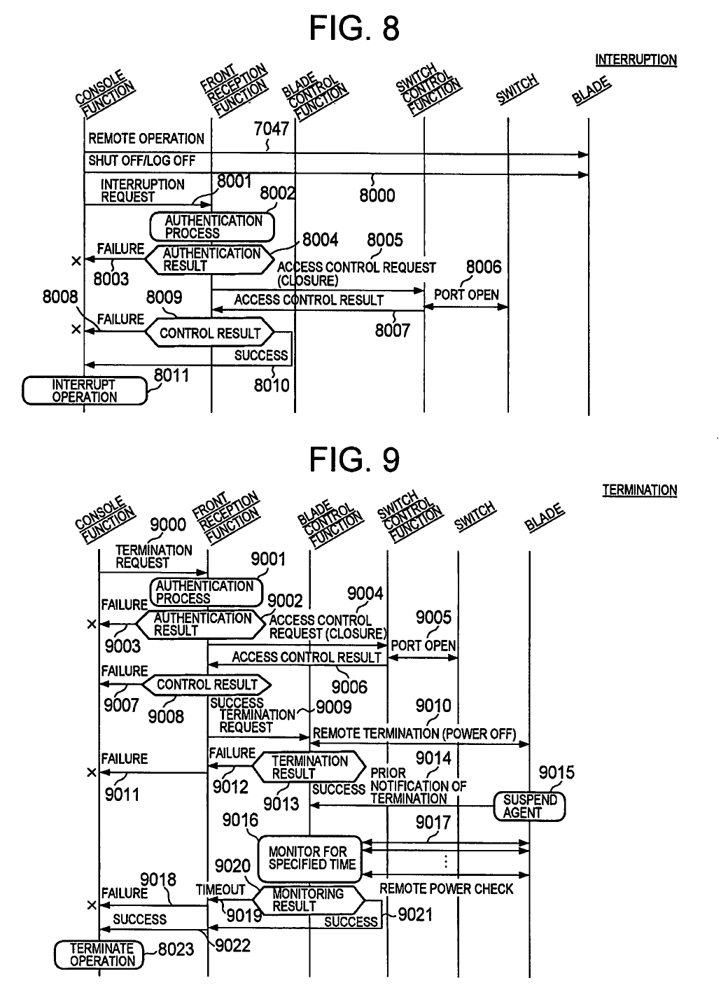

Next, an interruption operation is described. FIG. 8 is a sequence diagram illustrating the interruption operation in detail.

When interrupting an operation from a state in which a remote operation 7047 is being performs on the blade 1400 corresponding to the user terminal of the user, the user shuts off a remote connection screen or logs off the remote connection itself (process 8000). The console function 1601 has been monitoring the remote connection since the console function 1601 was activated. When the console function 1601 has detected the disconnection of the remote connection, the console function 1601 transmits the interruption request 8001 to the front reception function 1701. Accordingly, the user can simply close the remote connection screen or log off, without regard to the interruption operation in particular. The front reception function 1701, which has received the interruption request 8001, performs an authentication process for judging whether the interruption request 8001 has been made by an authorized user (process 8002), and judges the result thereof (process 8004).

When the authentication result fails, the front reception function 1701 transmits a failure response to the console function 1601, and ends the process (process 8003). The console function 1601, which has received the failure response 8003, displays a message, to the user, to the effect that the interruption process has failed. When the authentication result is a success, the front reception function 1701 transmits an access control request 8005 to the switch control function 1201. The switch control function 1201, which has received the access control request 8005, executes a process of closing the port with respect to the switch 1500 (process 8006). The switch control function 1201 transmits the result of the access control to the front reception function 1701 (process 8007).

The front reception function 1701, which has received the result of the access control, judges the result of the access control (process 8009). In cases where the access control fails, the front reception function 1701 responds to the console function 1601 to give notification of the failure, and ends the process (process 8008). The console function 1601, which has received the failure response 8008, displays, to the user, a warning message to the effect that the interruption process has failed and access control has also failed while the power is turned on, and that the system is therefore vulnerable to unauthorized access, to thereby bring the matter to the attention of the user. In response to this warning message, the user deals with the situation by, for example, turning off the power of the system.

In cases where the access control is a success, the front reception function 1701 responds to the console function 1601 to give notification of the success, and ends the process (process 8010). The console function 1601, which has received the success-response 8010, displays a message to the effect that the access control has been normally performed and that the blade 1400 is in a suspended state. In response to this message, the user suspends the remote operation (process 8011).

The sequence described above illustrates details of operations when an interruption is made.

Lastly, a termination operation is described. FIG. 9 is a sequence diagram illustrating the termination operation in detail.

When a user, who is in a state of performing the remote operation 7047 on the blade 1400 corresponding to the user terminal of the user or in the state where the remote operation is suspended 8011, wants to terminate the operation on the blade 1400 corresponding to the user terminal of the user and turn off the power of the blade 1400, the user transmits the termination request 9000 to the front reception function 1701 by using the console function 1601. The front reception function 1701, which has received the termination request 9000, performs an authentication process 9001 for judging whether the user making the termination request 9000 is an authorized user.

Specifically, the front reception function 1701 searches the management database 6200 for the user identifier included in the request. The authentication is judged as being successful when the management database 6200 includes a user identifier corresponding to the user. The authentication is judged as failing when the management database 6200 does not include a user identifier corresponding to the user. When it has been judged, in the authentication result judgment 9002, that the authentication has failed, the front reception function 1701 transmits an authentication failure response 9003 to the console function 1601, and ends the process. When the authentication is a success, the front reception function 1701 transmits an access control request 9004 to the switch control function 1201 in order to shut off access from the user to the blade 1400. The switch control function 1201, which has received the access control request 9004, executes a process of opening the port with respect to the switch 1500 (process 9005). The switch control function 1201 transmits the result of access control to the front reception function 1701 (process 9006).

The front reception function 1701, which has received the result of access control, judges the result of access control (process 9008). In cases where the access control fails, the front reception function 1701 responds to the console function 1601 to give notification of the failure (process 9007). It should be noted, however, that the front reception function 1701 performs a process of turning off the power of the blade 1400, irrespective of whether the result of access control is a success or a failure. Specifically, the front reception function 1701 transmits a termination request 9009 for turning off power to the blade 1400, to the blade control function 1301, and the blade control function 1301, which has received the termination request 9009, transmits a remote termination request 9010 to the blade 1400, executes the turning off of the power, and judges the result thereof (process 9013). When it has been judged that the result with respect to the remote termination request 9010 has failed, the front reception function 1701 transmits a failure response to the console function 1601, and ends the process (process 9011).

On the other hand, the blade 1400, which has received the remote termination request 9010, starts termination, and the agent function 1401 also terminates accordingly (process 9015). The agent function 1401 transmits, immediately before the agent function 1401 terminates, a prior notification of termination 9014 indicating that the agent function 1401 has started termination, to the blade control function 1301.

When the result with respect to the remote termination request 9010 is a success, the blade control function 1301 receives the prior notification of termination 9014. The blade control function 1301, which has received the prior notification of termination 9014, remotely checks the power source with respect to the blade 1400 for a specified period of time which is preset (processes 9016 and 9017). Also, even if the termination request 9000 has not been received, the blade control function 1301 remotely checks the power source with respect to the blade 1400 for a specified period of time which is preset by the administrator (processes 9016 and 9017) upon receiving the prior notification of termination 9014 from the blade 1400.

The blade control function 1301 judges the result of the power check (process 9020), and in cases where the complete termination of the blade 1400 is detected based on the remote monitoring of the power source during a preset timeout period, the blade control function 1301 determines that the termination of the blade 1400 has succeeded, responds to the console function 1601 through the front reception function 1701 to give notification of the termination success, and ends the process (processes 9021 and 9022). It should be noted, however, that in cases where the administrator or the user has directly controlled the blade 1400, the blade control function 1301 does not transmit the success-response (9021, 9022) to the console function 1601. The console function 1601, which has received the success-response 9022, displays a message to the effect that the blade 1400 is in a state where the termination control has been normally completed. In response to this message, the user terminates the remote operation (process 8023).

The blade control function 1301 judges the result of the power check (process 9020), and in cases where the complete termination of the blade 1400 cannot be detected based on the remote monitoring of the power source during a preset timeout period, the blade control function 1301 determines that the termination of the blade 1400 has failed, responds to the console function 1601 through the front reception function 1701 to give notification of the termination failure, and ends the process (processes 9019 and 9018). It should be noted, however, that in cases where the administrator or the user has directly controlled the blade 1400, the blade control function 1301 does not transmit the failure response (9019, 9018) to the console function 1601.

According to Embodiment 1, in the termination sequence, the port is closed through the access control prior to the shutoff of the power to the blade 1400, which produces an effect of protecting the blade 1400 against unauthorized access when the blade 1400 is terminated because the port is closed beforehand. However, in a system which does not require a high level of security, the order in which the access control and the shutting off of the power source are performed is not particularly limited, and the access control and the shutoff of the power source may be performed at the same time or in reverse order.

Described above is the termination process.

As described above, the detailed state of the blade control performed in response to any one of the connection request, the interruption request, and the termination request is obtained, to thereby enable the user to appropriately comprehend the access state of the blade 1400 and the status of the blade 1400.

Hereinbelow, a description is given of a method of maintaining a state with respect to the blade control.

In performing a process corresponding to the connection request or the termination request according to Embodiment 1, that is, in controlling the blade 1400 to activate or terminate the blade 1400, in response to a change of state of the blade 1400 or any failure which has occurred in the blade control, the blade control function 1301 updates information in the fields of the blade status 6102 and the failure status 6103 of the blade table 6100 managed by the management database 6200.

Examples of a specific procedure for updating each of the statuses by the blade control function 1301 include the following procedures.

First, the blade status 6102 is updated according to the following procedure.

In the connection sequence of FIG. 7, when the blade control function 1301 has received the agent activation notification 7014 and the activation result thereof has been a success (processes 7018 and 7019), the blade control function 1301 sets “agent activation” to the blade status 6102 of the management database 6200. Further, when the blade control function 1301 has received the remote communication service activation notification 7014 and the activation result thereof has been a success (processes 7026 and 7027), the blade control function 1301 sets “activation” to the blade status 6102 of the management database 6200. Also, in the termination sequence of FIG. 9, when the blade control function 1301 has received the prior notification of termination 9014 and the termination result has been a success (processes 9016, 9017, 9020, and 9021), the blade control function 1301 sets “suspended” to the blade status 6102 of the management database 6200.

The procedure of updating the blade status 6102 has been described above.

Next, the failure status 6103 is updated according to the following procedure.

When the blade control function 1301 performs any control with respect to the blade 1400 or obtains the status thereof, that is, when the blade control function 1301 has failed in performing any of the processes of the remote activation 7006, the remote termination 9010, and the remote power source check 9017, the blade control function 1301 sets “power source control failure” to the failure status 6103 of the management database 6200.

Also, in any one of the cases where the blade control function 1301 has not received the agent activation notification 7014 within a timeout period preset by the administrator and where the agent activation notification 7014 has been received within the timeout period but it has been explicitly determined that the activation result of the agent has failed (processes 7014, 7018, and 7017), the blade control function 1301 sets “address acquisition failure” to the failure status 6103 of the management database 6200.

Further, in anyone of the cases where the blade control function 1301 has not received the remote communication service activation notification 7022 within a timeout period preset by the administrator and where the remote communication service activation notification 7022 has been received within the timeout period but it has been explicitly determined that the activation result of the remote communication service has failed (processes 7022, 7026, and 7025), the blade control function 1301 sets “remote communication service activation failure” to the failure status 6103 of the management database 6200. Also, in cases where it has been determined, based on the remote communication service activation notification 7022 received by the blade control function 1301, that the blade 1400 has not been able to obtain an address for network communication which is necessary for performing remote access, the blade control function 1301 sets “address acquisition failure” to the failure status 6103 of the management database 6200.

Described above is the procedure of updating the failure status 6103.

As described above, changes in the statuses of the blades 1400 of users are registered on the management database 6200, to thereby uniformly manage the detailed statuses of the blades 1400 in the entire system. Accordingly, when a failure has occurred, it is possible to easily identify to what extent the system had been normally activated or suspended. From a practical point of view, an interface may also be provided to efficiently obtain and visualize the statuses of the blades 1400 uniformly managed by the management database 6200. In this case, to implement the interface, a program stored in the disk 2102 may be loaded onto the memory 2100 and executed.

Further, as regards the notification with respect to the terminal upon the connection operation, the interruption operation, or the termination operation, in a case where the notification is one of failure, the details of the failure may also be provided at the same time by using the failure status 6103.

### Embodiment 2

Embodiment 2 describes a process performed in a configuration where disk areas, which are allocated to users in a high-capacity storage device installed in a management center, are used, instead of using the hard disk in a PC.

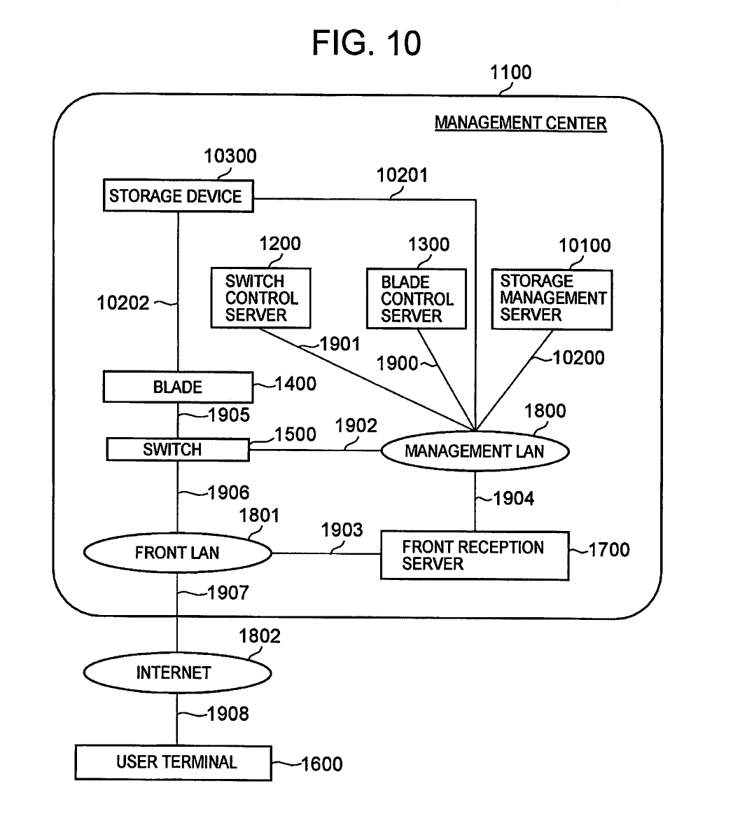

FIG. 10 is a system configuration diagram according to Embodiment 2. Embodiment 2 is similar to Embodiment 1 in system configuration, but is different from Embodiment 1 in that Embodiment 2 additionally includes a storage device 10300 and a storage management server 10100. The storage device 10300 is connected to the blade 1400 via a line 10202, and connected to the management LAN 1800 via a line 10201. The storage management server 10100 is connected to the management LAN 1800 via a line 10200, and manages the storage device 10300 through the line 10200, the management LAN 1800, and the line 10201.

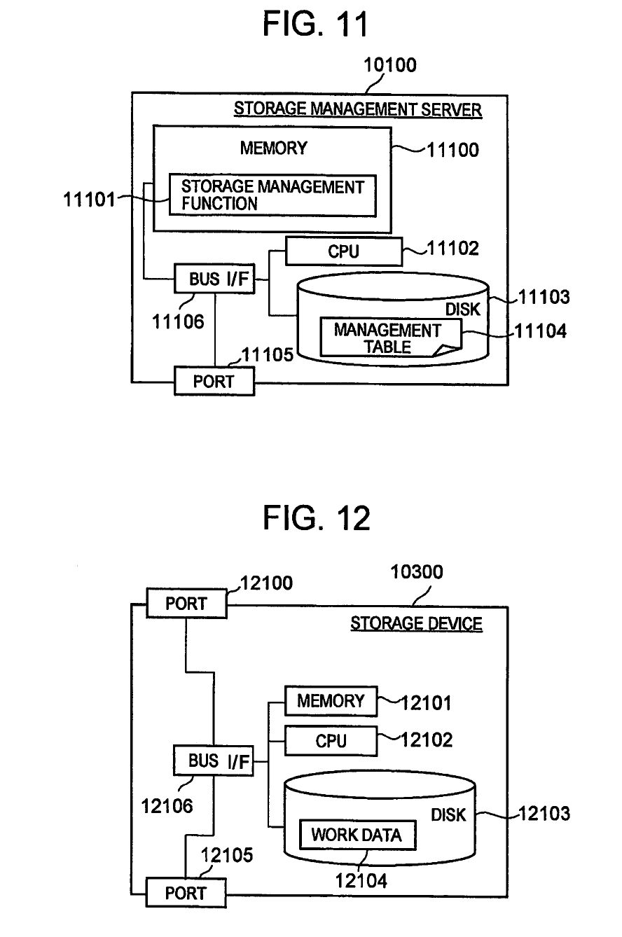

FIGS. 11 and 12 each illustrate a correspondence relation between a physical configuration and a logical configuration of the storage management server 10100 and the storage device 10300, respectively.

In FIG. 11, the storage management server 10100 includes a memory 11100, a CPU 11102, and a disk 11103 which are connected to one another through a bus IF 11106. The memory 11100 has a storage management function 11101, which is a management function of the storage device 10300, activated and held thereon. The disk 11103 of the storage management server 10100 stores a management table 11104 (herein after, referred to as management table 11104) for managing a correspondence relation between the storage device 10300 and a user. On the memory 11100, a process for allocating the disk 11103 of the storage management server 10100 to the blade 1400 used by a corresponding user in response to a request from the blade control server 1300 and executing an actual process of mounting the disk 11103 to the blade 1400 is running.

According to Embodiment 2, the management table 11104 is stored in the disk 11103 of the storage management server 10100. However, the storage location of the management table 11104 is not limited thereto as long as the management table 11104 is accessible from the storage management function 11101. Also, the storage management server 10100 includes at least one port 11105 for connecting to the management LAN 1800.

In FIG. 12, the storage device 10300 includes a memory 12101, a CPU 12102, and a disk 12103, which are connected to one another via a bus IF 12106. The disk 12103 stores work data 12104 of a user.

Next, a description is given of an operation in a process performed by the storage management server 10100 in response to each of the connection request and the termination request, with reference to a sequence diagram illustrating a specific procedure.

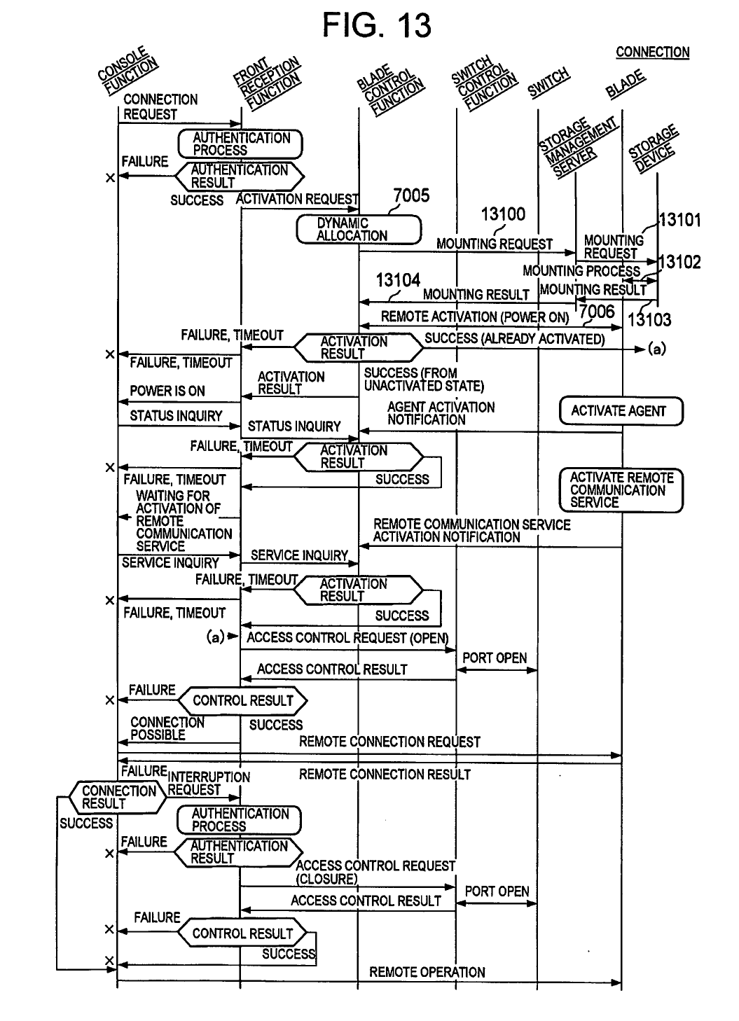

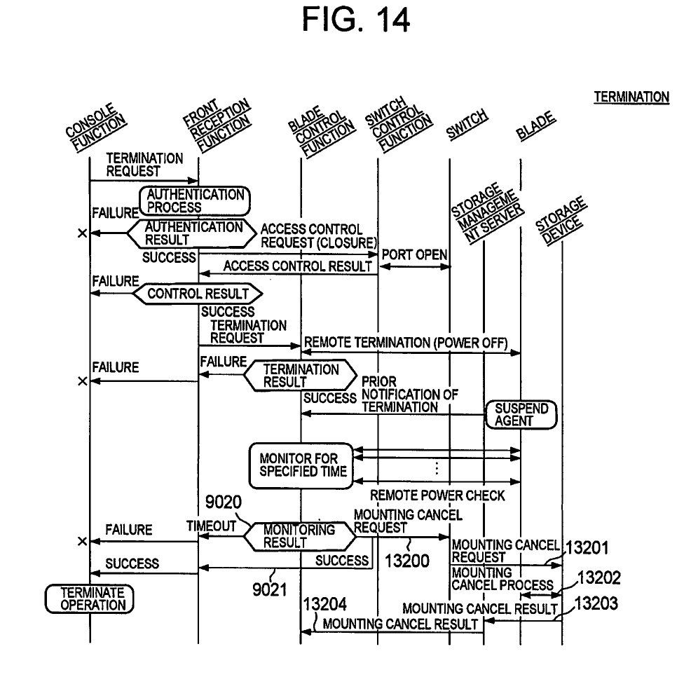

FIG. 13 is the sequence diagram illustrating operations in detail with respect to the requests made by a user.

A process corresponding to the connection request 7000 of the user is similar to the process in Embodiment 1 up to the process of dynamic allocation 7005 of the blade. After the process of dynamic allocation 7005 of the blade 1400, the blade control server 1300 first transmits, with respect to the storage management server 10100, a mounting request 13100 of the storage device 10300 corresponding to the blade 1400 to be used by the user, before transmitting the activation request to the blade 1400.

The storage management server 10100, which has received the mounting request 13100, refers to the correspondence relation between the user and the storage device 10300 stored in the disk 11103 of the storage management server 10100, retrieves a corresponding storage device 10300, and transmits, based on the search result, the mounting request 13101 to the storage device 10300. The storage device 10300, which has received the mounting request 13101, executes a process of actually mounting the storage device 10300 to the blade 1400 designated by the storage management server 10100, and completes the mounting (process 13102).

Further, the storage device 10300, which has performed the mounting process, responds to the storage management server 10100 to give notification of the result of the mounting process (process 13103), and the storage management server 10100 transmits the response to the blade control function 1301 as a mounting result (process 13104). It is not until when the blade control function 1301 receives the response, that the blade control function 1301 transmits a remote activation request 13105 to the blade 1400. The subsequent activation process is similar to the process in Embodiment 1.

According to Embodiment 2, the blade control function 1301 allocates the blade 1400 to the user. However, there may be adopted another configuration in which the blade control function 1301 passes information on users using the blades 1400 to the storage management server 10100, the blade control server 1300 determines, based on the information on the users, the blade 1400 to which the disk area is to be mounted, and the blade control function 1301 receiving the result of the determination remotely activates the corresponding blade 1400.

A process relating to the connection request has been described above.

Next, a process relating to the termination request is described.

A process to be performed in response to the termination request 9000 made by a user is similar to the process of Embodiment 1 up to the process of judging the result of the power source checking of the blade 1400 (process 9020). After the process of judging the result of the power source checking of the blade 1400 (process 9020) is completed, in cases where the result indicate a success, the blade control server 1300 transmits, to the storage management server 10100, a mounting cancel request 13200 of the storage device 10300 to the blade 1400 to be used by a user.

The storage management server 10100, which has received the mounting cancel request 13200, refers to the correspondence relation between users and the storage devices 10300 which is stored in the disk 11103 of the storage management server 10100, retrieves a corresponding storage device 10300, and transmits, based on the search result, the mounting cancel request 13201 to the storage device 10300. The storage device 10300, which has received the mounting cancel request 13201, executes an actual process of canceling the mounting, with respect to the blade 1400 designated by the storage management server 10100, to thereby complete the mounting cancellation (process 13202).

Further, the storage device 10300, which has performed the mounting cancellation process, responds to the storage management server 10100 to give notification of the result thereof (process 13203), and the storage management server 10100 transmits the response to the blade control function 1301 as a mounting cancel result (process 13204). The termination process other than the above is similar to the process of Embodiment 1.

The termination process has been described above.

As mentioned above, in a configuration where the blade 1400 and the work data are separate, even in a case where a blade 1400 to be used by a user is determined when the user is using the blade 1400, it is possible to correctly control the corresponding blade 1400.

Embodiment 1 and Embodiment 2 may be combined in an implementation. For example, even in a system configuration which includes a combination of a configuration in which the blade 1400 and the work data exist together and a configuration in which the blade 1400 and the work data are separate, it is possible to correctly control and manage the corresponding blade 1400 based on the system according to Embodiment 2.

### Embodiment 3

Embodiment 3 describes a process performed in a configuration where a switch control server is not provided.

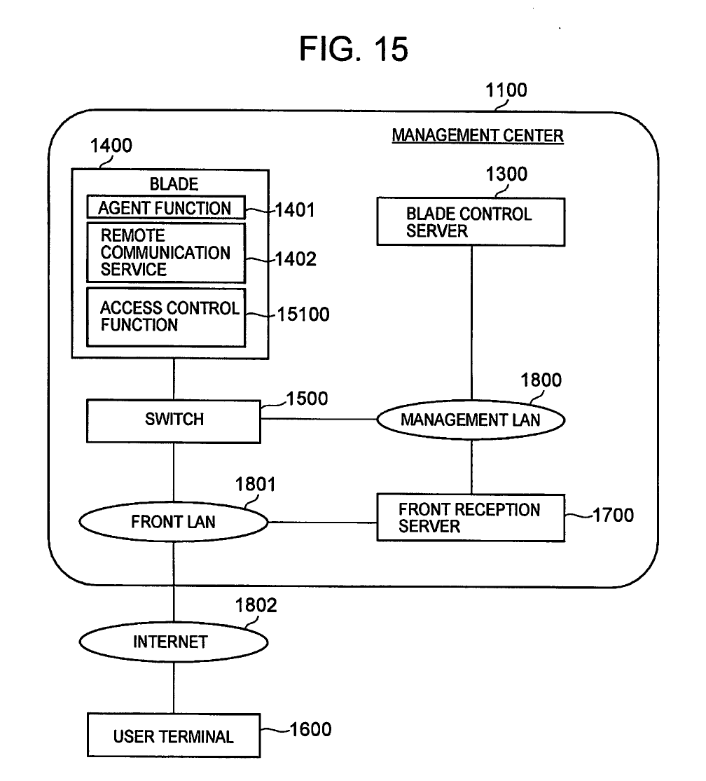

FIG. 15 is a system configuration diagram according to Embodiment 3. Embodiment 3 is similar to Embodiment 1 in system configuration, but is different from Embodiment 1 in that Embodiment 3 does not include the system control server 1200. Further, Embodiment 3 is different from Embodiment 1 in that an access control function 15100 is provided to the blade 1400 in Embodiment 3. The access control function 15100 filters packets received with respect to a network port of the blade 1400. The access control function 15100 discards packets from an arbitrary terminal and accepts transmission and reception of packets or discards the packets, with respect to a port used in accordance with a transmission control protocol (TCP) or a user datagram protocol (UDP) used by an arbitrary application on the blade 1400.

Next, an operational description is given with reference to a sequence diagram illustrating a specific procedure regarding processes to be performed by the blade control server 1300 and the agent function 1401 with respect to each of the connection request and the termination request.

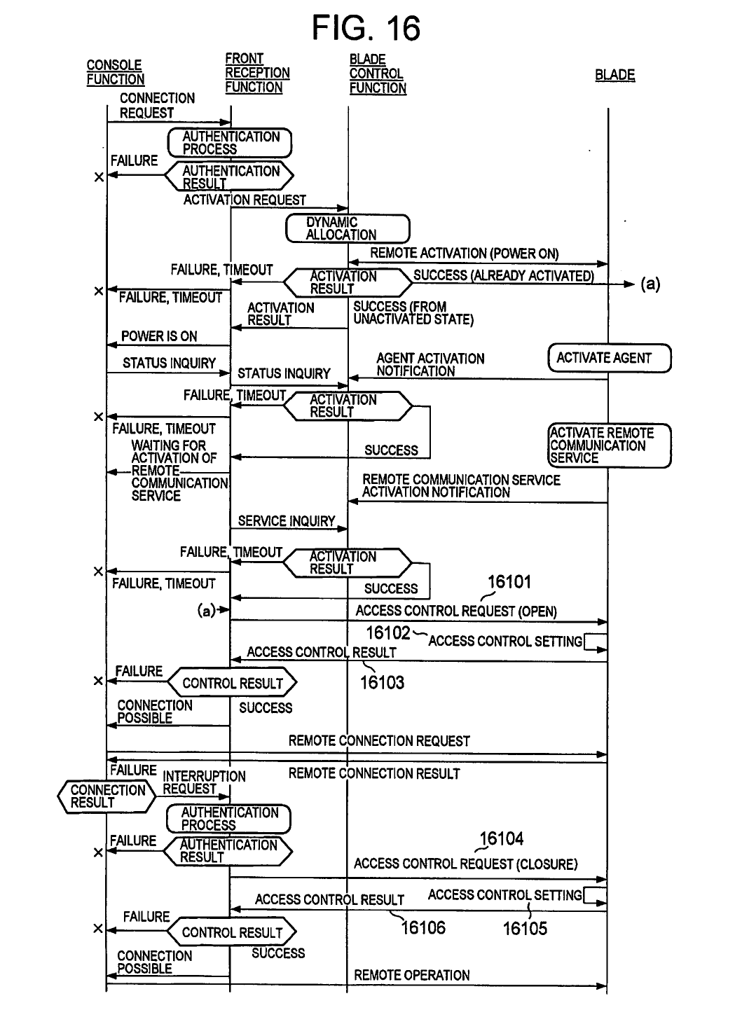

FIG. 16 is the sequence diagram illustrating in detail an operation with respect to each of the requests made by the user.

A process with respect to the connection request 7000 of the user is similar to the process of Embodiment 1 up to the process of obtaining the activation result 7026. In cases where it has been judged that the activation result is one of success, the front reception function 1701 transmits an access control request for opening, to the agent function 1401 on the blade 1400 (process 16101). The agent function 1401, which has received the access control request, configures the access control settings for the blade 1400 (process 16102). The access control settings are configured by using an access control setting function of the blade 1400, such that the blade 1400 receives a packet to be transmitted to the remote communication service only with respect to the access from the corresponding host. The agent function 1401 transmits the result of the above-mentioned process as an access control result (process 16103). The process to be performed by the front reception function 1701 thereafter is similar to the process performed in cases where the access control result 7030 is received from the switch control function 1201 in Embodiment 1. The process is different from that of Embodiment 1 in that the following process is performed instead of the processes performed with respect to the access control request (process 7041 to process 7043) of Embodiment 1.

The front reception function 1701 transmits the access control request for closure to the agent function 1401 on the blade 1400 (process 16104). The agent function 1401, which has received the access control request, configures the access control settings for the blade 1400 (process 16105). The access control settings are configured by using the access control setting function of the blade 1400, such that a packet to be transmitted to the remote communication service 1402 is discarded even with respect to the access from the corresponding host. The agent function 1401 transmits the result of the above-mentioned process as an access control result (process 16106).

The sequence illustrating the connection operation has been described above in detail.

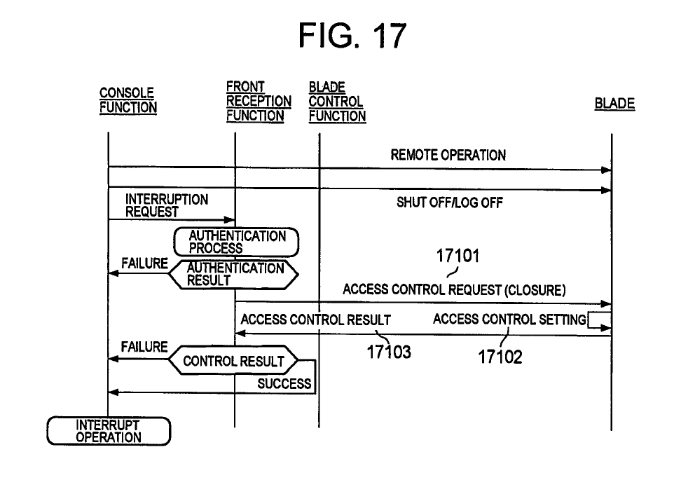

Next, an interruption operation is described. FIG. 17 is a sequence diagram illustrating the interruption operation in detail.

The interruption process is similar to the process of Embodiment 1 up to the process performed in cases where the authentication result is judged to be a failure in the authentication process (process 8004). In cases where the authentication process has succeeded, the front reception function 1701 transmits the access control request for closure to the agent function 1401 on the blade 1400 (process 17101). The agent function 1401, which has received the access control request, configures the access control settings for the blade 1400 (process 17102). The access control settings are configured by using the access control setting function of the blade 1400, such that a packet to be transmitted to the remote communication service is discarded even with respect to access from the corresponding host. The agent function 1401 transmits the result of the above-mentioned process as an access control result (process 17103). The process to be performed by the front reception function 1701 thereafter is similar to the process performed in cases where the access control result is received from the switch control function 1201 in Embodiment 1 (process 8007 and thereafter).

The sequence illustrating the interruption operation has been described above in detail.

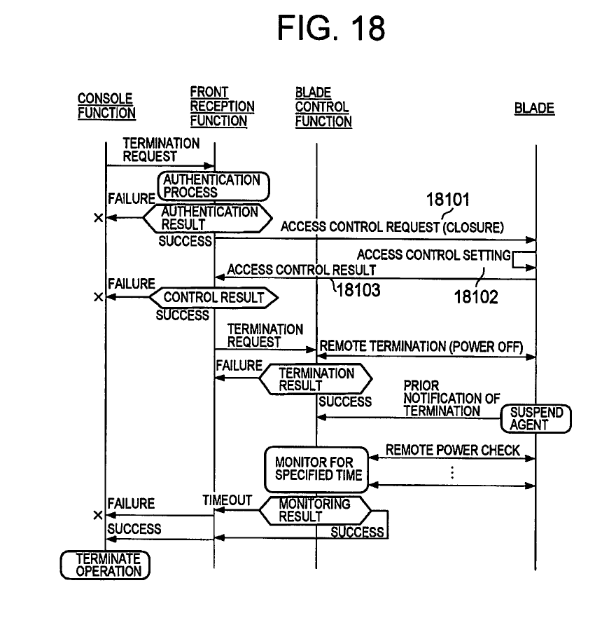

Lastly, a termination process will be described. FIG. 18 is a sequence diagram illustrating the termination operation in detail.

The termination process is similar to the process of Embodiment 1 up to the process performed in cases where the authentication result is judged to be a failure in the authentication process (process 9001). In cases where the authentication process has succeeded, the front reception function 1701 transmits the access control request for closure to the agent function 1401 on the blade 1400 (process 18101). The agent function 1401, which has received the access control request, configures the access control settings for the blade 1400 (process 18102). The access control settings are configured by using the access control setting function of the blade 1400, such that a packet to be transmitted to the remote communication service is discarded even with respect to access from the corresponding host. The agent function 1401 transmits the result of the above-mentioned process as an access control result (process 18103). The process to be performed by the front reception function 1701 thereafter is similar to the process performed in cases where the access control result is received from the switch control function 1201 in Embodiment 1 (process 9008 and thereafter).

The sequence illustrating the termination operation has been described above in detail.

In Embodiment 3, the access control function 15100 of the blade 1400 is used, instead of controlling the switch 1500. However, another configuration may also be adopted in which the agent function 1401 on the blade 1400 holds port information of the switch 1500 to which the blade 1400 is connected, and access authority to the switch, and controls the port with respect to the corresponding switch 1500 when the access control request is received from the front reception function 1701.

With the above-mentioned configuration, it is possible to notify the user that an environment is available in which the blade is protected against unauthorized access, even if the switch control function 1201 which controls a network switch is not provided.

### Embodiment 4

Embodiment 4 describes processing performed in a configuration which does not include a blade control server, but in which the user terminal 1600 directly controls the blade 1400 and obtains the status thereof.

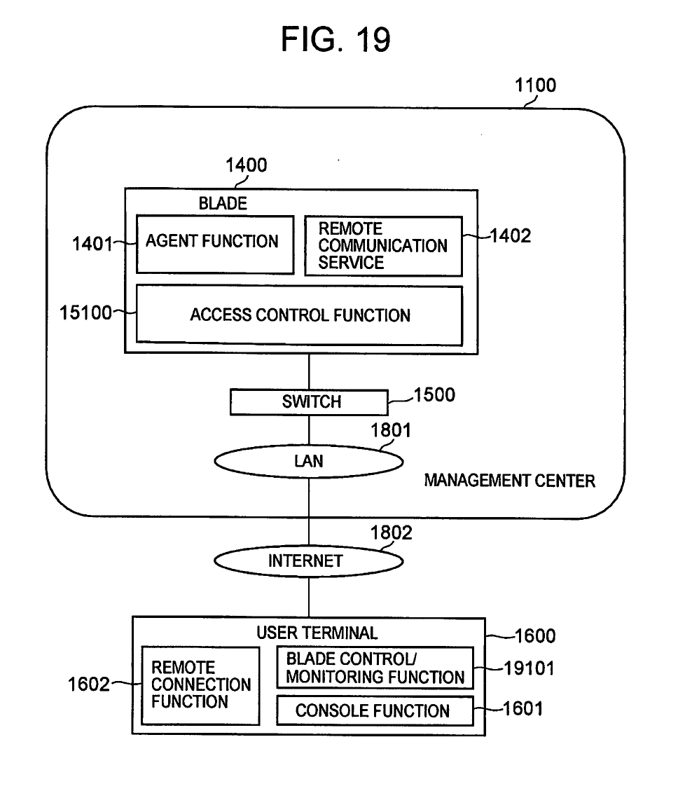

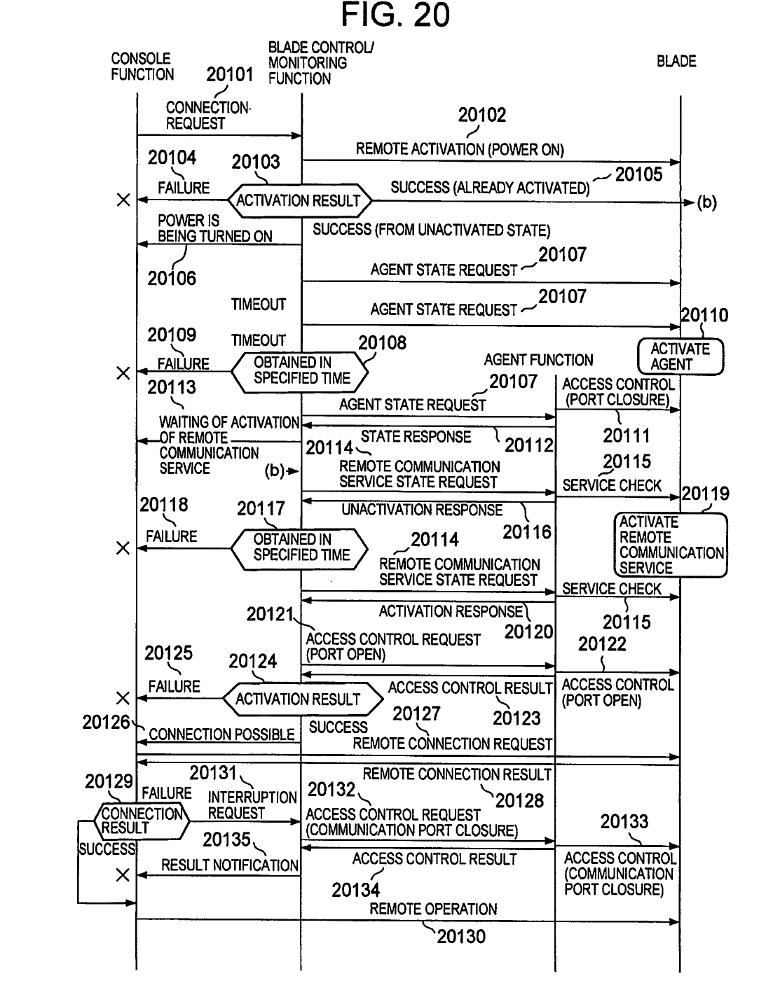

FIG. 19 is a system configuration diagram according to Embodiment 4. The user terminal 1600 includes a blade control/monitoring function 19101 in addition to the remote connection function 1602. Also, the blade 1400 includes the agent function 1401, the remote communication service 1402, and the access control function 15100. The operation of the access control function 15100 is similar to the operation thereof in Embodiment 3.

The console function 1601 in Embodiment 4 holds information on the blade 1400 (for example, an IP address thereof or authority information for controlling the blade 1400) used by a user. The information may be defined in advance in the console function 1601 or may be obtained from a user by the console function 1601 when the user uses the blade 1400.

Next, an operational description is given with reference to a sequence diagram illustrating a specific procedure regarding processes with respect to each of the connection request, the interruption request, and the termination request.

FIG. 20 is the sequence diagram illustrating an operation in detail with respect to the power-on request made by a user.

The connection request made by the user is received by the blade control/monitoring function 19101 through the console function 1601 (process 20201). At this time, the information on the blade 1400 is also transmitted to the blade control/monitoring function 19101. The blade control/monitoring function 19101, which has received the request, performs a blade activation process with respect to a target blade 1400. Specifically, the blade control/monitoring function 19101 transmits a remote power-ON command to the blade 1400 and turns on the power thereof (process 20102). Next, the blade control/monitoring function 19101 judges whether the result of the turning on of the power was a success or a failure (process 20103). In cases where the result of the turning on of the power fails, or in cases where no response has been received even after a lapse of a predetermined timeout period, the blade control/monitoring function 19101 responds to the console function 1601 to give notification of the activation failure, and ends the process (process 20104). Upon receiving the activation failure, the console function 1601 displays, to the user, the fact that the activation of the power has failed.

On the other hand, there are two cases, in which the result of the turning on of the power is a success, a case where the power has just been turned on from a suspended state as an initial state, and a case where the power has already been turned on. The difference between the two cases can be obtained as an execution result of the remote power ON command.

In the case where the power has just been activated from the suspended state and the turning on of the power is a success, the blade control/monitoring function 19101 responds to the console function 1601 to the effect that the power is ON (process 20105). Upon receiving the response indicating that the power is ON, the console function 1601 displays, to the user, that an OS is being activated. After that, the blade control/monitoring function 19101 transmits an agent state request (process 20107) to the agent function 1401 on the blade 1400 which is targeted for control and monitoring for a predetermined time. The agent state request is a request for the agent function 1401, and therefore a timeout occurs if the agent function 1401 is not activated. When the timeout occurs, the blade control/monitoring function 19101 retransmits the same request to the agent function 1401 (process 20107). In cases where the agent function 1401 does not respond the state thereof within a specified period of time, the blade control/monitoring function 19101 notifies the console function 1601 that the state of the agent has not been obtained (process 20108 and process 20109). Upon receiving the notification, the console function 1601 displays, to the user, the fact that the activation of the agent has not been confirmed during the activation of the OS. On the other hand, when the agent function 1401 is activated on the blade 1400, the blade 1400 is first set, by using the access control function 15100 on the blade 1400, such that the port number used by the remote communication service 1402 is prohibited from being accessed by all the hosts (process 20111). As a result, despite the termination process of the previous time, no one can communicate with the remote communication service 1402 upon activation. After that, the agent function 1401 waits for a request from the blade control/monitoring function 19101. The agent function 1401, which has received a request from the blade control/monitoring function 19101, transmits a state response which notifies the activation of the agent function 1401 to the blade control/monitoring function 19101 which has made the request (process 20112). Upon receiving the response, the blade control/monitoring function 19101 notifies the console function 1601 that the activation of the remote communication service 1402 is in a waiting state (process 20113). Upon receiving the notification, the console function 1601 displays, to the user, the fact that the activation of the remote communication service 1402 is in a waiting state.

After notifying the waiting state of the activation of the remote communication service 1402 to the console function 1601, the blade control/monitoring function 19101 transmits a remote communication service state request to the agent function 1401 on the blade 1400 (process 20114). The agent function 1401, which has received the request, performs remote communication service checking (process 20115). In cases where it has been found that the remote communication service 1402 is not activated as a result of the checking, the agent function 1401 sends back an inactivation response to the blade control/monitoring function 19101 (process 20116). The blade control/monitoring function 19101, which has received the inactivation response, retransmits the remote communication service state request to the agent function 1401 after a predetermined interval. In cases where the inactivation responses have been received over a specified time, the blade control/monitoring function 19101 notifies the console function 1601 of the failure of the remote communication service check. Upon receiving the notification, the console function 1601 displays, to the user, that the remote communication service 1402 cannot be activated.

After the remote communication service 1402 has been activated on the blade 1400 (state 20119), when the agent function 1401 receives the remote communication service state request, the activation state of the remote communication service 1402 is identified through the remote communication service check, and the agent function 1401 transmits an activation response (process 20120). The blade control/monitoring function 19101, which has received the activation response, transmits the access control request for open (process 20121). The agent function 1401, which has received the access control request, configures the access control settings for the blade 1400 (process 20122). To configure the access control settings, the access control function 15100 is used as in the process of Embodiment 3. The agent function 1401 transmits the result of the above-mentioned process as an access control result (process 16103).

The blade control/monitoring function 19101 judges the control result based on the received response (process 20124). In cases where the access control result is one of failure, the blade control/monitoring function 19101 notifies the console function 1601 of the failure of the control (process 20125). The console function 1601 displays, to the user, the fact that the blade 1400 cannot be accessed because the access control has failed despite the activation of the remote communication service 1402 succeeding. In cases where the access control result is one of success, the blade control/monitoring function 19101 responds to the console function 1601 that it is possible to establish connection to the blade 1400 (process 20126). The console function 1601, which has received the response, transmits the remote connection request to the blade 1400, and obtains the result thereof (process 20127 and process 20128).

When the result of the remote connection request has been judged as being successful, as a result of the judgment of the result of the remote access connection (process 20129), the user starts a remote operation with respect to the blade 1400 from the user terminal 1600 through the connection established from the remote connection function 1602 to the remote communication service 1402 (process 20130).

When the result of the remote connection request has been judged as one of failure, as a result of the judgment of the result of the remote access connection request, the console function 1601 tries to change the access control. Accordingly, in cases where the result of the remote connection request is one of failure, the console function 1601 notifies the blade control/monitoring function 19101 of the interruption request (process 20131). The blade control/monitoring function 19101, which has received the interruption request, transmits the access control request for closure to the agent function 1401 on the blade 1400 (process 20132). The agent function 1401, which has received the access control request, configures the access control settings for the blade 1400 as in Embodiment 3 (process 20133). The access control settings are configured by using the access control setting function of the blade 1400, such that a packet to be transmitted to the remote communication service 1402 is discarded even with respect to access from the corresponding host. The agent function 1401 transmits the result of the above-mentioned process as an access control result, to the blade control/monitoring function 19101 (process 20134). The blade control/monitoring function 19101 notifies the console function 1601 of the access control result. In cases where the access control result is one of failure, the console function 1601 displays, to the user, a warning to the effect that the remote connection has failed and access control has also failed while the power is turned on, and that the system is therefore vulnerable to unauthorized access, to thereby bring the matter to the attention of the user. In response to this warning, the user turns off the power of the system, for example, to deal with the situation.

When the access control result is one of success, the console function 1601 displays a message to the effect that the access control has been normally performed despite the failure of the remote connection. In response to this, the user tries to reestablish the connection, for example, to deal with the situation.

In cases where the result of the turning on of the power has been judged as being successful, as a result of the judgment of the activation result with respect to the connection request (20103), the blade control/monitoring function 19101 determines that the blade 1400 is activated, and proceeds to the process following that of transmitting the remote communication service state request (process 20114).

The above describes processing in cases in which power-on result is already active.

The sequence illustrating the connection operation has been described in detail above.

Next, an interruption operation is described in detail.

When the user shuts off the remote operation or suspends the remote operation by logging off, the communication of the remote access is disconnected. The agent function 1401 on the blade 1400, which is monitoring the communication state of the remote access, executes the access control process for closure with respect to a network setting environment, in cases where the communication state is cleared. Accordingly, the network setting environment is set such that the remote communication service 1402 cannot be remotely accessed.

The sequence illustrating the interruption operation has been described above in detail.

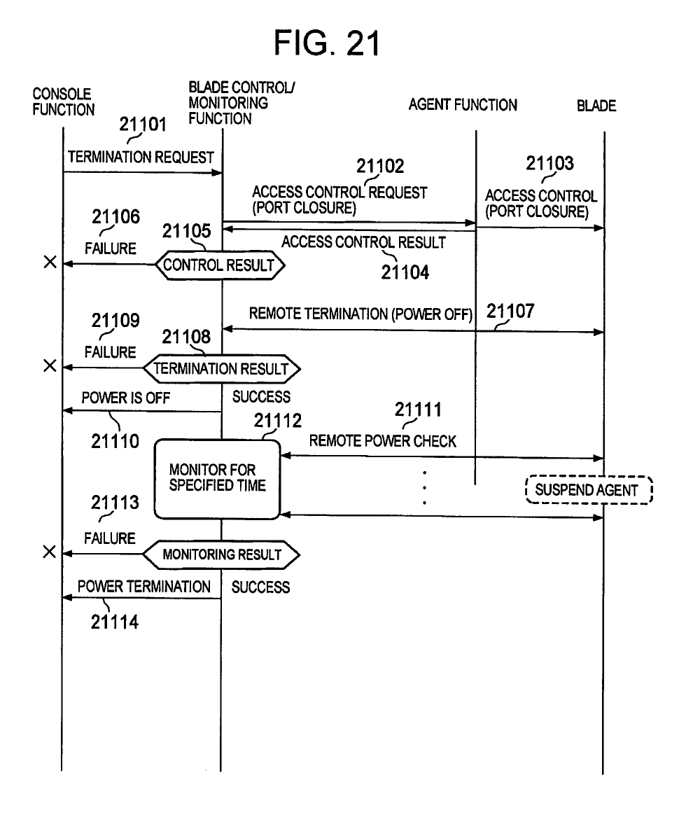

Lastly, an operation of the termination process will be described in detail. FIG. 21 is a sequence diagram illustrating the termination operation in detail.

When a user is performing the remote operation on the blade 1400 corresponding to the user terminal 1600 of the user or is suspending the remote operation, and wishes to terminate the operation on the blade 1400 and turn off the power of the blade 1400, the user transmits a termination request 21101 to the blade control/monitoring function 19101 by using the console function 1601 (process 21101).

The blade control/monitoring function 19101 transmits the access control request for closure with respect to the agent function 1401 on the target blade 1400 (process 21102). The agent function 1401, which has received the access control request for closure, configures the settings in which remote access to the remote communication service 1402 is prohibited, by using the access control function 15100 (process 21103). Then, the agent function 1401 transmits the result thereof to the blade control/monitoring function 19101 (process 21104).

The blade control/monitoring function 19101 judges the response from the agent function 1401 (process 21105). In cases where the response is one of failure, the blade control/monitoring function 19101 notifies the console function 1601 of the failure (process 21106). Upon receiving the notification, the console function 1601 notifies, to the user, the fact that the power is to be turned off without performing the access control (process 21106).

The blade control/monitoring function 19101 performs a process of turning off the power of the blade 1400, irrespective of whether the result of the access control is one of success or a failure. Specifically, the blade control/monitoring function 19101 transmits a remote termination request 21107 to the blade 1400, executes the turning off of the power, and judges the result thereof (process 21108). When the result with respect to the remote termination request 21107 is one of failure, the blade control/monitoring function 19101 notifies the console function 1601 of the failure, and ends the process (process 21108 and process 21109). Upon receiving the notification, the console function 1601 notifies the user that the termination of the blade 1400 has failed. In cases where the termination of the blade 1400 has succeeded, the console function 1601 is notified of the turning off of the power (process 21110). Upon being thus notified, the console function 1601 notifies the user that the blade is being terminated.

When the result with respect to the remote termination request 21107 is a success, the blade control/monitoring function 19101 remotely checks the power source with respect to the blade 1400 for a specified time which is preset (process 21111).

The blade control/monitoring function 19101 judges the result of the power check (process 21112), and in cases where the complete termination of the blade 1400 is detected based on the remote monitoring of the power source during a preset timeout period, the blade control/monitoring function 19101 determines that the termination of the blade 1400 has succeeded, notifies the console function 1601 of the termination success, and ends the process (process 21114). The console function 1601, which has received the notification, displays a message to the effect that the blade 1400 is in a state where the termination control has been normally completed. In response to this, the user terminates the remote operation.

The blade control/monitoring function 19101 judges the result of the power check, and in cases where the complete termination of the blade 1400 has not been detected based on the remote monitoring of the power source during a preset timeout period, the blade control/monitoring function 19101 determines that the termination of the blade 1400 has failed, notifies the console function 1601 of the termination failure, and ends the process (process 21114). Upon receiving the notification, the console function 1601 notifies the user that the blade has been normally terminated.

Described above is the termination process.

Through the above-mentioned processes, according to Embodiment 4, it is possible to perform control and monitoring of the blade 1400 directly from the user terminal 1600, even without the front reception server 1700 or the switch control server 1200.

According to Embodiment 4, another configuration may be adopted in which the blade control/monitoring function 19101 notifies authentication information for judging whether a user making a request is the authorized user of the blade 1400 each time a request is made, in the communication between the blade control/monitoring function 19101 and the agent function 1401, the agent function 1401 has a function of authenticating the user, and it is judged, by the authentication function, whether a request is authorized or not. With this configuration, even if a request is made by an unauthorized user, the user is not allowed to perform communication.

An other configuration may also be adopted as Embodiment 4 in which the agent function 1401 does not have the access control function. This configuration applies to a case where it is not necessary to give consideration to unauthorized access. In this case, the process load to be imposed on the agent function 1401 is reduced, and therefore the amount of usage of resources on the blade 1400 is also reduced.

### Embodiment 5

Embodiment 5 describes a process performed in a configuration in which the blade control function 1301 does not exist, and the state of the blade 1400 is directly identified by the user terminal 1600.

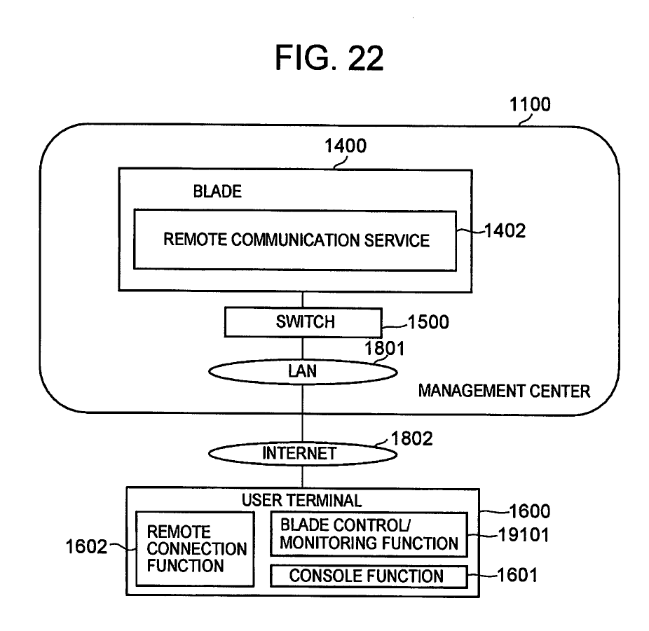

FIG. 22 is a system configuration diagram according to Embodiment 5. Embodiment 5 is similar to Embodiment 4 in configuration, but Embodiment 5 is characterized in that the blade 1400 merely includes the remote communication service 1402.

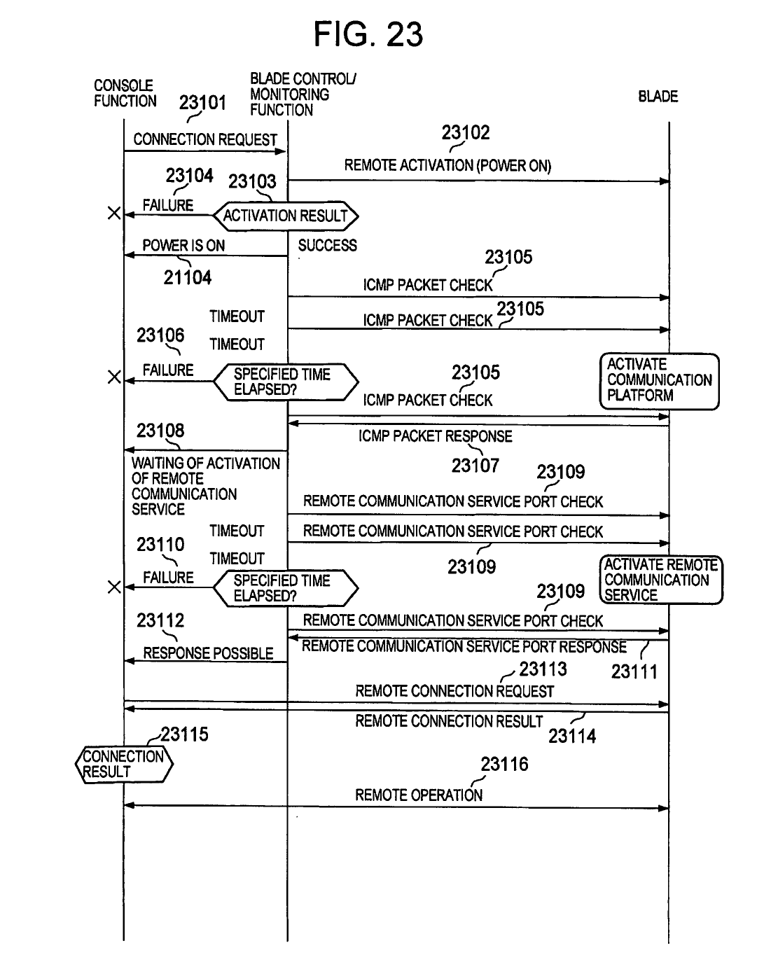

FIG. 23 is a sequence diagram illustrating an operation in detail with respect to the power-on request made by a user.

The connection request from the user is received by the blade control/monitoring function 19101 through the console function 1601 (process 23101). At this time, information on the blade 1400 is also transmitted to the blade control/monitoring function 19101. The blade control/monitoring function 19101, which has received the request, performs the blade activation process with respect to a target blade 1400. Specifically, the blade control/monitoring function 19101 transmits a remote power-ON command to the blade 1400 and turns on the power thereof (process 23102). Next, the blade control/monitoring function 19101 judges whether the result of the turning on of the power is a success or a failure (process 23103). In cases where the result of the turning on of the power is one of failure, or in cases where no response is been received even after a lapse of a predetermined timeout period, the blade control/monitoring function 19101 responds to the console function 1601 to give notification of the activation failure, and ends the process (process 23104). Upon receiving the activation failure, the console function 1601 displays, to the user, the fact that the activation of the power has failed.

In cases where the result of the turning on of the power is a success, the blade control/monitoring function 19101 transmits a command, such as an internet control message protocol (ICMP) packet, for confirming the state of a computer, to the blade 1400 which is targeted for control and monitoring for a predetermined time (herein after, a description is given by taking the ICMP packet as an example). The request leads to a timeout if a communication platform of the blade 1400 is not activated. When the timeout occurs, the blade control/monitoring function 19101 retransmits the same packet to the blade 1400 (process 23105). In cases where no response has been received with respect to the ICMP packet within a predetermined period of time, the blade control/monitoring function 19101 notifies the console function 1601 that the activation of the blade 1400 has not been confirmed, and ends the process (process 23106). Upon receiving the notification, the console function 1601 displays, to the user, the fact that the activation confirmation cannot be obtained during the activation of the OS.

On the other hand, if the communication platform has been normally activated, the blade 1400 transmits a response 23107 with respect to the ICMP packet to the blade control/monitoring function 19101.

Upon receiving the ICMP packet response, the blade control/monitoring function 19101 notifies the console function 1601 that the activation of the remote communication service 1402 is in a waiting state (process 20113). Upon receiving the notification, the console function 1601 displays, to the user, the fact that the activation of the remote communication service 1402 is in a waiting state. After notifying the console function 1601 that the activation of the remote communication service 1402 is in a waiting state, the blade control/monitoring function 19101 performs a remote communication service port check with respect to a port to be used by the remote communication service 1402 which is to be activated on the blade 1400 (process 23109). The port check leads to a timeout if the remote communication service 1402 of the blade 1400 is not using the port (that is, the remote communication service 1402 has not activated). When the timeout occurs, the blade control/monitoring function 19101 retransmits the same packet to the blade 1400 (process 23109). In cases where no response has been received with respect to the port check within a predetermined period of time, the blade control/monitoring function 19101 notifies the console function 1601 that the activation of the remote communication service 1402 has not been confirmed, and ends the process (process 23110). Upon receiving the notification, the console function 1601 displays, to the user, that the communication service has not been activated.

If the remote communication service 1402 has been normally activated, the response 23111 is sent back with respect to the port check.

Upon receiving the response 23111 with respect to the port check, the blade control/monitoring function 19101 notifies the console function 1601 that the remote communication service 1402 is available for response (process 23112). The console function 1601, which has received the notification, transmits the remote connection request to the blade 1400 and obtains the result thereof (process 23113 and process 23114).

When the result of the remote connection request is judged as being successful as a result of the judgment of the result of the remote access connection (process 23115), the user starts remote operation with respect to the blade 1400 from the user terminal 1600 through the connection established from the remote connection function 1602 to the remote communication service 1402 (process 23116). In cases where the result of the remote connection request fails, the console function 1601 notifies the user that the remote connection request has been a failure although the power is turned ON (process 23117).

A sequence illustrating the connection operation has been described in detail above.

When carrying out an interruption of the blade 1400, nothing in particular is performed.

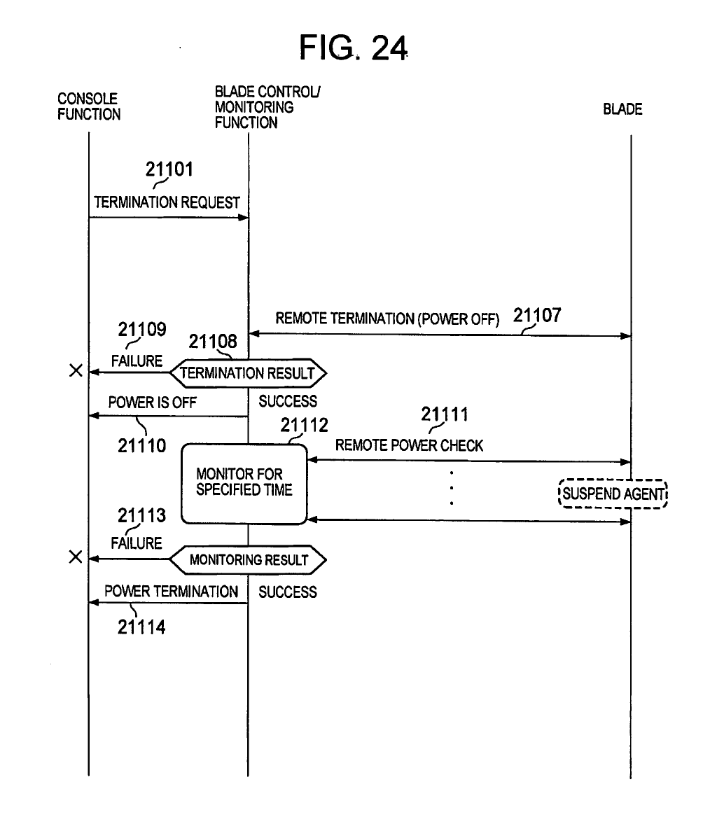

Lastly, an operation of the termination process will be described in detail. FIG. 24 is a sequence diagram illustrating the termination operation in detail.

The termination process is similar to that of Embodiment 4. However, Embodiment 5 is different from Embodiment 4 in that the blade control/monitoring function 19101 immediately performs a power termination process of the blade 1400 upon receiving the termination request. The process thereafter is similar to the process of Embodiment 4.

The termination process has been described above.

In Embodiment 5, the access control is not performed. However, through the above-mentioned process, it is possible to directly control and monitor the blade 1400 from the user terminal, without providing a special agent to the blade 1400.

It should be noted that the above-mentioned embodiments have been described by taking as an example cases where the blade 1400 or the user terminal 1600 includes a function such as the agent function 1401 or the access control function 15100. However, the present invention may also be applied to cases where a program which implements the above-mentioned functions is introduced to the blade 1400 or to the user terminal 1600. Further, the program may be stored in a storage device in a computer or an external storage device in advance, or may be introduced as necessary to the external storage device through a removable storage medium or a communication medium (such as a wired network, a radio network, or an optical network, or a carrier wave or a digital signal on the network).

What is claimed is:

1. A management server which is connected from a terminal device via a network and manages a plurality of computers, wherein, during a time period between when the terminal device makes a connection request to one of the plurality of computers and when the terminal device is notified of availability of connection to the one of the plurality of computers,
the management server transmits a command which implements a process to be executed by the one of the plurality of the computers, with respect to the one of the plurality of computers, and notifies the terminal device of a result of the process.

2. A management server according to claim 1, wherein the command which implements the process comprises a command which turns on power to the one of the plurality of the computers.

3. A management server according to claim 2, further comprising a database having a failure status which includes information relating to a failure in each of the plurality of computers,
wherein in a case where content of notification to the terminal device is negative, the management server refers to the failure status to obtain details of a failure corresponding to the negative notification and notifies the terminal device of the details of the failure, in addition to the notification.

4. A management server according to claim 3, wherein when a result of a command to the one of the plurality of computers ends in failure, the failure status is set in accordance with content of the result.

5. A management server which is connected from a terminal device via a network and manages a plurality of computers, wherein during a time period between when the terminal device makes a connection request to one of the plurality of computers and when the terminal device is notified of availability of connection to the one of the plurality of computers,
the management server transmits, to the one of the plurality of computers, a command which requests intermediate progress of a process performed in the one of the plurality of computers until the terminal device is notified of the availability of the connection to the one of the plurality of computers, and notifies the terminal device of a result of the command which requests the intermediate progress.

6. A management server according to claim 5, wherein the command which requests the intermediate progress is transmitted from the terminal device.

7. A management server according to claim 6, wherein the command which requests the intermediate progress comprises a command which asks whether an agent function can be activated or not, the agent function being activated after an OS of the one of the plurality of computers has been activated.

8. A management server according to claim 7, further comprising a database having a failure status which includes information relating to a failure in each of the plurality of computers,
wherein in a case where content of notification to the terminal device is negative, the management server refers to the failure status to obtain details of a failure corresponding to the negative notification and notifies the terminal device of the details of the failure, in addition to the notification.

9. A management server according to claim 8, wherein when a result of a command to the one of the plurality of computers ends in failure, the failure status is set in accordance with content of the result.

10. A management server which is connected from a terminal device via a network and manages a plurality of computers, wherein, during a time period between when the terminal device makes a connection request to one of the plurality of computers and when the terminal device is notified of availability of connection to the one of the plurality of computers,
the management server transmits, to the one of the plurality of computers, a command which requests intermediate progress of a process performed in the one of the plurality of computers until the terminal devices is notified of the availability of the connection to the one of the plurality of computers, and notifies the terminal device of a result of the command which requests the intermediate progress.

11. A management server according to claim 10, wherein the command which requests the intermediate progress is transmitted from the terminal device.

12. A management server according to claim 11, wherein the command which requests the intermediate progress comprises a command which asks whether a remote communication service function can be activated or not, the remote communication service function managing connection from the one of the plurality of computers to the terminal device.

13. A management server according to claim 12, further comprising a database having a failure status which includes information relating to a failure in each of the plurality of computers,
wherein in a case where content of notification to the terminal device is negative, the management server refers to the failure status to obtain details of a failure corresponding to the negative notification and notifies the terminal device of the details of the failure, in addition to the notification.

14. A management server according to claim 13, wherein when a result of a command to the one of the plurality of computers ends in failure, the failure status is set in accordance with content of the result.
